(19) United States
(12) Patent Application Publication
(10) Pub. No.: US 2007/0033114 A1
(43) Pub. Date: Feb. 8, 2007

(54) Method and system for comparing medical products

(76) Inventor: Teri Minor, Memphis, TN (US)

Correspondence Address: PETER L. BREWER BEARMAN, CALDWELL, & BERKOWITZ;LAW FIRM, 165 MADISON AVENUE, SUITE 2000, MEMPHIS, TN, 38103, US

(21) Appl. No.: 11/498,612

(22) Filed: Aug. 3, 2006

Related U.S. Application Data
(60) Provisional application No. 60/705,021, filed on Aug. 3, 2005.

(51) Int. Cl. G06Q 30/00

(52) U.S. Cl. 705/26

(57) ABSTRACT

A method for comparing comparable products such as medical products is provided. It is anticipated that each product will have a corresponding product code. In one aspect, the method includes the steps of receiving textual information from a first seller as to medical products, and receiving textual information from a plurality of additional sellers as to their respective medical products. The information may include the first seller's and each additional seller's prices for their respective medical products. The information may also include the product code assigned by the respective first seller and the plurality of additional sellers for the products. The method may also include the steps of placing the information from the sellers onto a database, assigning categories to the medical products of the sellers based upon features of the respective medical products, correlating comparable products as between the sellers, and providing software that permits a user to selectively compare information for either the first seller's medical products to the plurality of additional sellers' comparable products, or the plurality of additional sellers' products to the first seller's comparable medical products.

### STATEMENT OF RELATED APPLICATIONS

This application claims the benefit of U.S. Provisional Patent Application No. 60/705,021, filed Aug. 3, 2005. That application is entitled “Method and System for Comparing Medical Products.” The provisional application is incorporated herein in its entirety by reference.

### BACKGROUND OF THE INVENTION

1. Field of the Invention

The present invention relates to the comparison of products. More specifically, the invention relates to a software-based method and system for facilitating the comparison of medical products of various competitors or sellers.

2. Description of the Related Art

It is intuitive for purchasers to compare prices and features of products from various sources in selecting a product for purchase. Consumers “comparison shop” when buying groceries, cars, and a quantum of other products. More recently, individual consumers have been able to comparison shop online through such web-based systems as eBay.com, AutoTrader.com and Expedia.com. Such systems operate through software that enables a consumer to select criteria such as “Honda S-2000” and then review listings from various potential sellers of such vehicles. Such listings will frequently include the price of the vehicle and other defining information such as year of manufacture and mileage.

In the business world, comparison-based shopping has been a manual task. This is particularly true in the medical industry where purchasers have compared available products by reviewing voluminous product catalogs to determine product features and prices. In the medical industry, this remains a highly cumbersome task. In this respect, a hospital or medical practice seeking to stock its facility with medical devices and pharmaceuticals must compare the vast number of devices and drugs available before ordering. Product catalogs or lists from certain manufacturers may list thousands of medical devices or drugs having Incrementally different features and variables, and all individually priced. For instance, there are over 500 medical devices available on the market from over ten manufacturers relating just to knee implants.

Therefore, a need exists for a software-based system that enables purchasers of medical products to quickly compare features and prices of comparable products from a number of sources. A need further exists for a web-based system whereby prospective purchasers can select a category of medical products, enter a code for that product, and then compare that product to products of competitors by price and features.

### SUMMARY OF THE INVENTION

A method for comparing products such as medical products is provided. It is anticipated that each product will have a corresponding product code. In one aspect, the method includes the steps of receiving textual information from a first seller and a plurality of additional sellers as to their respective medical products. The information from the first seller and the additional sellers is placed onto a database. Such information may include each seller's prices for the respective medical products. The information may also include the product code assigned by the respective first seller and the plurality of additional sellers and a description of the medical products. The method may also include the steps of assigning categories to the medical products of the first seller and the plurality of additional sellers based upon features of the respective medical products, correlating comparable products as between the first seller and the plurality of additional sellers, and providing software that permits a user to selectively compare information for either the first seller's medical products to the plurality of additional sellers' comparable products by assigned category and product code, or the plurality of additional sellers' products to the first seller's comparable medical products by assigned category and product code.

The software may operate through the internet or other multiple-user platform. In this instance, the user interfaces with the software through a web-based platform. Alternatively, the software is operated on a personal computer.

The medical products may be different types of products. In one aspect, they are medical devices. In other aspects they are pharmaceutical products, biologic products, or surgical instruments and equipment.

The categories for the medical products may also be of different types. In one aspect, the assigned categories are selected from the group consisting of “all medical products,” “surgical instruments,” “navigational instruments,” “hips,” “knees,” “shoulders,” “elbows,” “feet,” “hands” and “spinal implants.”

In one aspect, the step of providing software comprises providing software that permits a user to selectively compare information for either the first seller's medical products to one of the plurality of additional sellers' products by product code, or one of the plurality of additional sellers' products to the first seller's medical products by product code. The software may further permit the user to export a price list to a spreadsheet program. Further, the software may permit the user to design and print out customized worksheets that include selected product information.

A system for comparing information concerning medical products is also provided herein. It is again contemplated that each product would have a product code. In one embodiment, the system includes a user interface for a server operator, a network interface comprising a web browser and a data link, and a server defining a web-based platform having a processor, memory and software for enabling the server operator to communicate with a plurality of users through a global data network. The web-based platform enables the users to select a product category, and select a method for comparing products within the selected product category. The selected method may be either a comparison of a seller's product to a comparable product of a competitor, or a comparison of a competitor's product to a comparable product of the seller. The user may select the competitor or enter the product code of the medical product to implement the comparison.

In one aspect, the comparison of products made using the system includes published prices for the products. It may also, or alternatively, include a published description for the products.

In one aspect, the web-based platform enables the user to view information for a product that represents an upgrade. In this instance, when the selected method of comparison is to compare the seller's product to that of a competitor, then the upgraded product is that of the seller. When the selected method of comparison is to compare the competitor's product to that of the seller, then the upgraded product is that of the competitor.

In addition to the above inventions, a method for comparing medical products as between sellers is also provided. Again, each medical product has a product code. The method may first comprise the step of accessing a computer program through a user interface. The computer program has information concerning the medical products from the sellers, such sellers comprising a manufacturer and a plurality of additional sellers. In addition, the method includes the steps of selecting a category of medical products from a menu on the program; making an election as to whether to (a) compare information concerning a medical product of the manufacturer with information concerning the comparable medical product of one of the sellers, or (b) compare information concerning a medical product of one of the sellers with information concerning a comparable medical product of the manufacturer; selecting which of the plurality of additional sellers with which to make the product comparison; entering the product code of the first medical product; and viewing comparative information of the first medical product.

The step of accessing a computer program may be performed in different ways. For instance, the step of accessing a computer program may be accomplished by accessing a web page on a global network. Alternatively, the step may be performed by running a software program on a personal computer. The software program may be operated on the personal computer through a compact disc or may be downloaded from the internet or shared on a network.

The medical products may be different types of products. In one aspect, they are medical devices. In other aspects they are pharmaceutical products, biologic products, or surgical instruments and equipment.

In one embodiment, if the user elects to compare information concerning a medical product of the manufacturer with information concerning the comparable medical product of one of the plurality of additional sellers, the user enters the product code of the selected seller and then views comparative information between the selected seller's product and the manufacturer's product. The user may further view comparative information between the selected seller's product and the manufacturer's upgrade products. If the user elects to compare information concerning a medical product of one of the plurality of additional sellers with the comparable medical product of the manufacturer, the user may, in one embodiment, enter the product code of the manufacturer and then view comparative information between the manufacturer's product and the selected seller's product. In another aspect, the user may further view comparative information between the manufacturer's product and the selected seller's upgrade products.

### BRIEF DESCRIPTION OF THE DRAWINGS

So that the manner in which the above recited features of the present invention can be better understood, certain drawings, flow charts and screenshots are appended hereto. It is to be noted, however, that the appended figures illustrate only selected embodiments of the inventions and are therefore not to be considered limiting of scope, for the inventions may admit to other equally effective embodiments, formats and applications. For example, the screenshots represent specific expressions of web pages, but numerous other expressions may be employed.

FIG. 1 presents a system for comparing information as to medical products of a plurality of manufacturers or sellers, in one embodiment.

FIG. 2 is a flowchart showing steps for using the comparative software of the present invention, in one embodiment.

FIG. 3 presents an illustrative screenshot for further using the software of FIG. 2, in one embodiment. This demonstrates a welcome page for the software.

FIG. 4A is another illustrative screenshot for using the software of FIG. 2. FIG. 3B(1) demonstrates an introduction page for the software.

FIG. 4B, which may be part of FIG. 4A allows the user to select a category of products.

FIG. 5 presents an illustrative screenshot for the software that allows the user to make an election as to the type of product comparison to be made.

FIG. 6A(1) is an illustrative screenshot for using the software of FIG. 2, in one embodiment. Here the user selects a company with which to compare a target product.

FIG. 6B(1) shows a next illustrative screenshot. Here, the user enters a product code of a competitor (or the selected company).

FIG. 6C(1) presents an illustrative screenshot for the software of FIG. 2, whereby the user views and compares the competitor's product with one or more products of a particular company, such as comparable products of his or her own company.

FIG. 6A(2) is an illustrative screenshot for using the software of FIG. 2, in one embodiment. Here the user selects a company whose product is to be compared with a target product, such as a product of his or her own company.

FIG. 6B(2) shows a next illustrative screenshot. Here, the user enters a product code of the target product.

FIG. 6C(2) presents an illustrative screenshot for the software of FIG. 2, whereby the user views and compares one of his or her own products with one or more products of a competitor (or other company).

FIG. 7 is an illustrative screenshot for using the software of FIG. 2, in one embodiment. This permits a user to export a price list to the user's computer.

### DETAILED DESCRIPTION

Definitions

The term “seller” refers to any individual or entity offering medical products for sale. The seller may, for example, be a manufacturer, a wholesaler, a distributor or a sales representative.

The term “user interface” means any software-driven apparatus such as any computer, mainframe, client, PDA or code-driven apparatus that may be placed in electrical communication with a global data network such as the worldwide web.

The term “comparable” refers to a product that is considered to be useful for the same or substantially similar procedure or treatment. Such “comparable” products need not necessarily be FDA approved, but are nevertheless on the market.

The term “user” means any individual or entity using the software. Preferably, the user is a licensed user, though this disclosure does not so require.

The term “product code” refers to any identification system employed by a product seller, manufacturer or distributor. This term includes, but is not limited to, the terms “SKU, “Stock Keeping Unit,” “Product Number,” “Parts Number” or “Production Code.”

### Description of Specific Embodiments

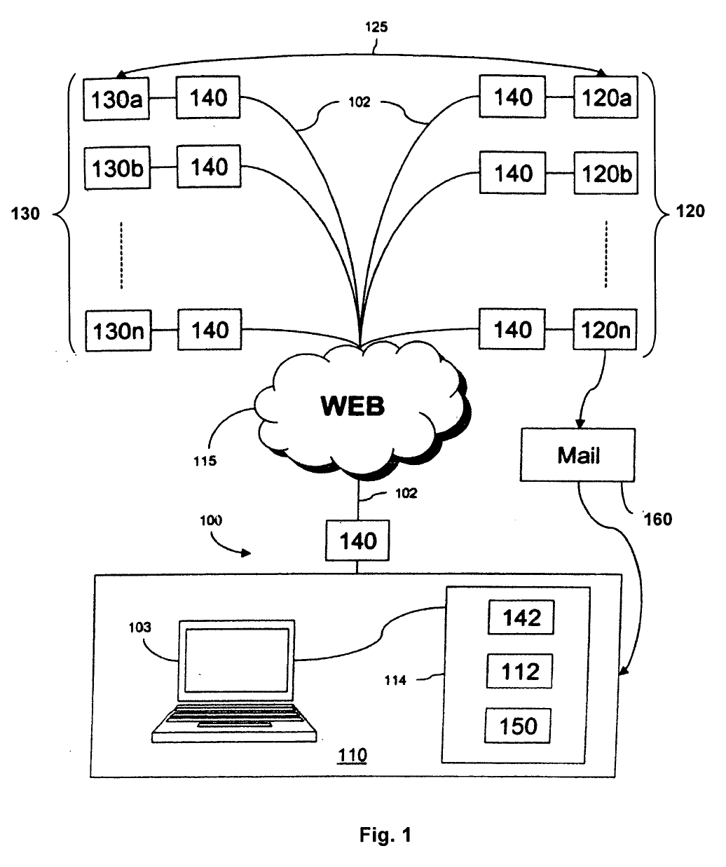

FIG. 1 presents a system 100 for facilitating the comparison of medical products, in one embodiment. The system 100 first comprises a server 110. The server 110 is any software driven device that may be placed in electrical communication with a data network such as the worldwide web 115. A communication link between the server 110 and the web 115 is shown at 102. The link may be wireless, or may be a telephone or digital cable line. A modem or Ethernet card (not shown) typically connects the server 110 to the communication link 102.

In the exemplary arrangement of FIG. 1, the server 110 is a desktop computer. The computer 110 may be free-standing or may be part of a local area network. The computer 110 typically includes a user interface 103 such as a keyboard, a screen and a pointing device (not shown). The computer 110 also includes a processor unit 114 which holds software and communicates commands to and from the user interface 103. The software will include an operating system such as the known Unix™ operating system, Microsoft Windows™ operating system, or Linux™ operating system. The software will also include a plurality of applications for performing various features such as electronic mail.

The server 110 includes a website 112. The website 112 is placed in communication with the web 115 by a network interface 140. The network interface 140 is typically an internet service provider, or “ISP,” which enables the website 112 to be presented to a plurality of remotely located system users 120, 130 on the web 115. A web browser 142 is installed in the computer 110 to facilitate communication of the website 112 from the computer 110. The browser 142 may be any one of a number of commercially available browsers such as Netscape Navigator™ or Internet Explorer™. In this manner, the server 110 provides a web-based platform for a business.

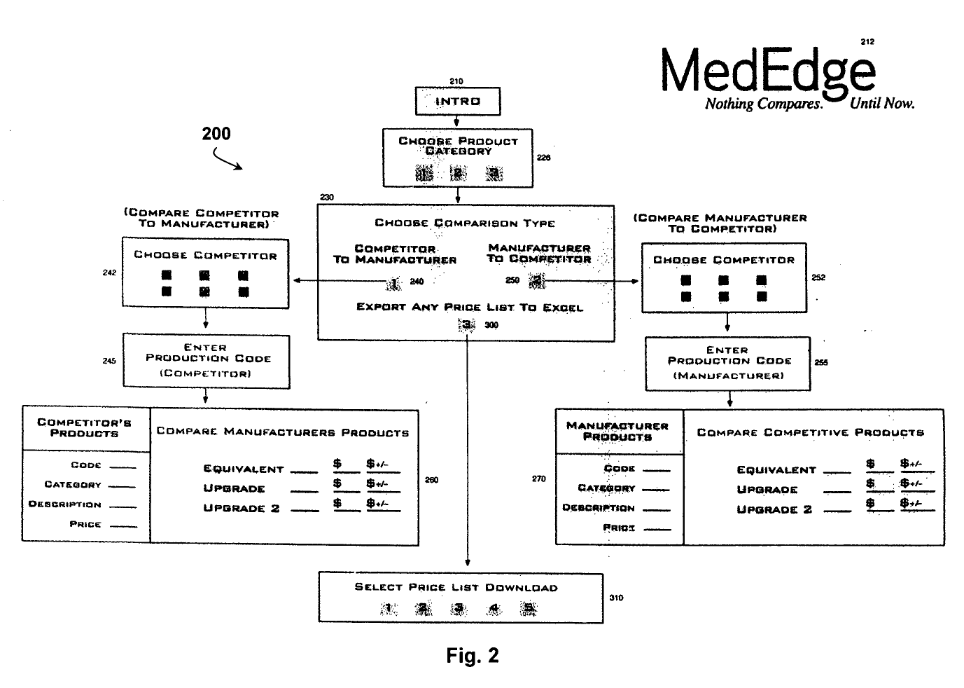

The computer 110 includes a memory 150 for storage of data and instructions. The memory 150 also forms a database that holds information acquired from product sellers (described below and identified at “120”). The database 150 may be freestanding or may be remotely associated with the processor 114 on the computer 110. Of particular importance, the processor unit holds software for operating the methods of the present invention based upon the data from the product sellers. The software is shown schematically at 200 in FIG. 2, and will be described further below.

The software 200 is intended to be used by a plurality of users 120, 130. FIG. 1 shows a plurality of users 120a, 120b, . . . and 130a, 130b, . . . . The term “users” is intended to be generic, and encompasses any individual using either the software 200 or the system 100. Non-limiting examples include manufacturer's representatives, sales representatives, product developers or testers, hospital staff, medical group employees, or health care providers themselves. Additional examples are provided below.

Each of the users 120, 130 also employs a network interface 140 such as an internet server operator. The interface 140 enables the users 120, 130 to establish contact with the website 112 on the server 110. The network interface 140 will include a web browser which enables the users 120, 130 to establish contact with the server operator's website 112 through the worldwide web 115. A communication link 102 is provided between each network interface 140 and the web 115, which may be either a wired or a wireless link.

In FIG. 1, users 120 represent sellers. The sellers 120 may include, for example, pharmaceutical companies and medical device companies, as well as their sales representatives, product designers and marketing personnel. Such sellers 120 may supply their product information to the operator of the software 200. The relationship between a seller 120 and a software operator is depicted by Box 160 of FIG. 1. It is understood though that the software operator may collect the seller's data through public or private sources apart from direct receipt from a seller 120.

In FIG. 1, users 130 represent purchasers. The purchasers 130 might include, for example, hospitals and their purchasing staff, clinics and their purchasing staff, GPO (group purchase organization) staff, and even doctors or other health care providers themselves.

The purpose of the system 100 is to allow users such as sellers 120 and purchasers 130 to compare prices and other features for comparable medical products from multiple manufacturers or sellers 120. The system 100 is implemented through software. As noted, the software is shown at 200 in FIG. 2. In one aspect, the software 200 is accessed and operated through the website shown at Box 112 of FIG. 1. It is understood that FIG. 1 demonstrates only one embodiment for implementing the comparative steps of the present invention. Users 120, 130 may alternatively license, purchase or otherwise use the software 200 either by purchasing a laptop having the software already downloaded, by directly downloading the software 200 through the web 115, or by purchasing the software 200 on a portable medium such as a CD or DVD. Indeed, it is preferred that the users 120, 130 obtain the software 200 directly through distribution of a CD, and then accept a license agreement through a “click wrap” means on the CD itself. Individual CD's would be purchased from an owner or distributor up front, and different click wrap agreements may be provided for different CD's depending upon the licensing arrangement with the user 120, 130. Thus, for example, a seller 120 might enter into a multi-user license agreement that permits numerous sales representatives to obtain and use CD's. On the other hand, a purchaser 130 would, for example, enter into a single user license agreement. In this scenario, the sellers 120 would pay substantially more for use of the software than the purchasers 130.

In one business arrangement, the sellers 120 receive CD's having software 200 customized to their specific company. The license agreement would be a multi-user agreement that would not only permit the seller 120 to distribute CD's to sales representatives and product developers within the company 120, but to also distribute the CD's to select purchasers 130 who happen to be actual or prospective customers.

Whether the software is operated through a website 112 on a global network 115, or on a distributed CD or computer, the sellers 120 and purchasers 130 will interact with one another apart from the software in order to sell/purchase medical products. Such interaction is depicted by line 125 of FIG. 1. The software 200 facilitates the comparison of available medical products as between the sellers 120. Such medical products may be pharmaceuticals, medical devices (including implants), surgical instruments, navigational equipment (such as cameras and monitors), biologic products (such as bone growth proteins) or other medical products.

Moving now to FIG. 2, this figure presents a flowchart showing steps by which a seller 120, a purchaser 130, or any other user may use the software 200. In order to implement the software 200, the user 120, 130 either actuates the software on his or her computer, or accesses the software through the website 112, depending upon how the software is provided.

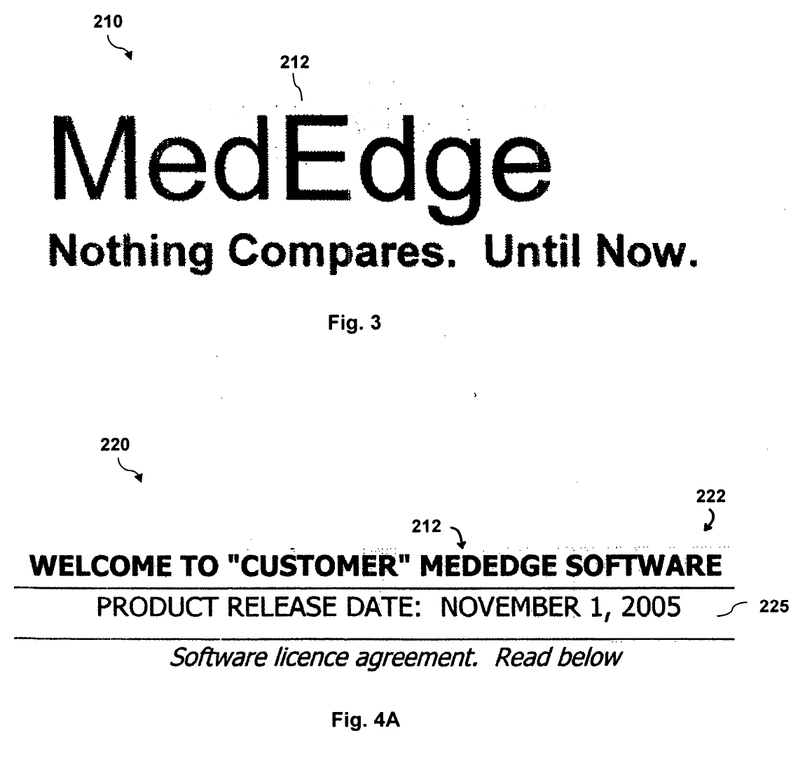

A home or “welcome” page is provided. An illustrative welcome page is shown at 210 in FIG. 3. Where the software 200 is part of a web-based platform, page 210 would appear upon typing in or linking to a domain name on the web 115. Where the software is distributed directly to the user 120, 130, page 210 appears immediately upon loading the software 200. In either instance, page 210 serves as the welcome page. The illustrative welcome page presents the logo 212 of the software owner or system operator. Here, the mark MedEdge™ is presented. Of course, it is understood that the inventions herein are not limited to the use of this mark or even the use of this type of welcome page 210. Music or an anthem may be optionally played in response to opening page 210.

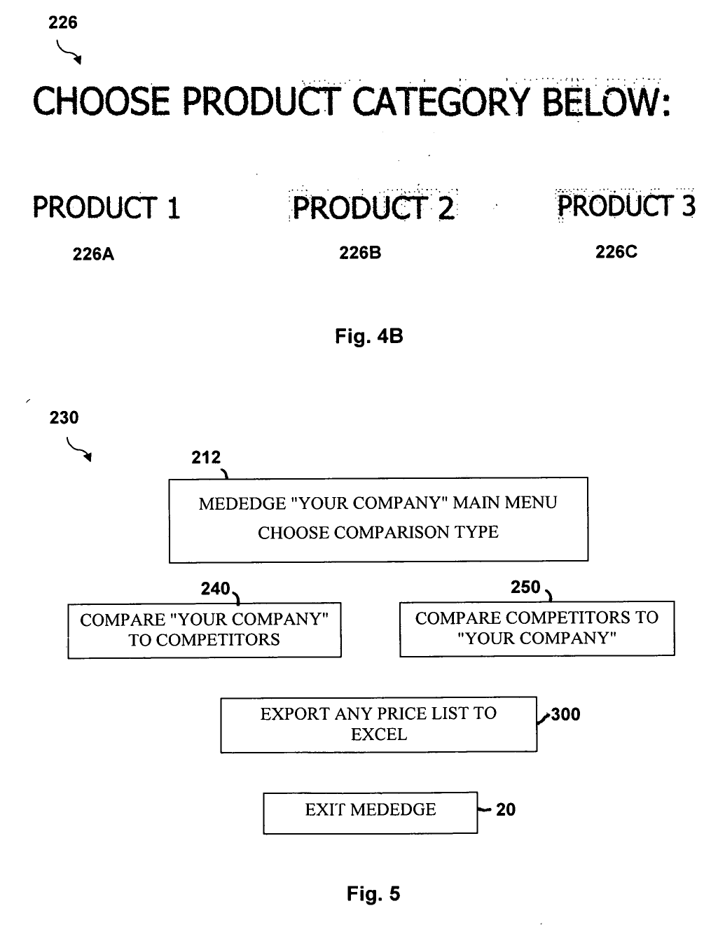

Following the welcome page 210, an introduction page 220 appears. The introduction page 220 is presented, in one embodiment, as a screenshot at FIG. 4A. The illustrative introduction page 220 includes a banner 222. Such a banner 222 might be used where the software 200 is customized for a specific seller 120. The illustrative banner 222 includes a statement concerning the release date for the pricing and other product information of the seller 120.

The introduction page 220 will include a link or click-through button 225 for a “Software License Agreement.” In one aspect, upon first accessing the introduction page 220, the user must click this button 225 and “Agree” to the terms of the license before accessing further pages. Any desired disclaimers may also appear upon clicking the license agreement button 225.

FIG. 4B may be part of FIG. 4A, and allows the user to select a category of products.

After all license agreement provisions, restrictions and disclaimers have been accepted, the user 120 or 130 is next presented with a choice for using the software 200 concerning the type of product to be compared. This selection step is demonstrated at Box 226 of FIGS. 2 and 4B. Depending upon the intended seller 120, 130 or market, one, two, three or even more product categories may be provided. In the illustrative screenshot of FIG. 4B, three separate product categories 226a, 226b and 226c are shown. Examples of such categories 226a, 226b, 226c include:

“All Medical Products”

“Medical Devices”

“Hips”

“Knees”

“Hands and Wrists”

“Shoulders and Elbows”

“Spinal Implants”

“Feet”

“Surgical Instruments”

“Navigational Tools”

“Biologic Products”

“Pharmaceuticals” and

“Cardiology Drugs.”

It is understood that the present methods are not limited to any specific categories of medical products, and that the selection step of Box 226 may be customized to meet the specific medical market of a defined set of users 120, 130. For example, the seller 120 might be a medical device company desiring to use a CD showing product categories of “Spinal Implants”, “Surgical Instruments” and “Biologic Products.” Such a CD would then be used to make sales presentation to health care provider doing spinal surgery.

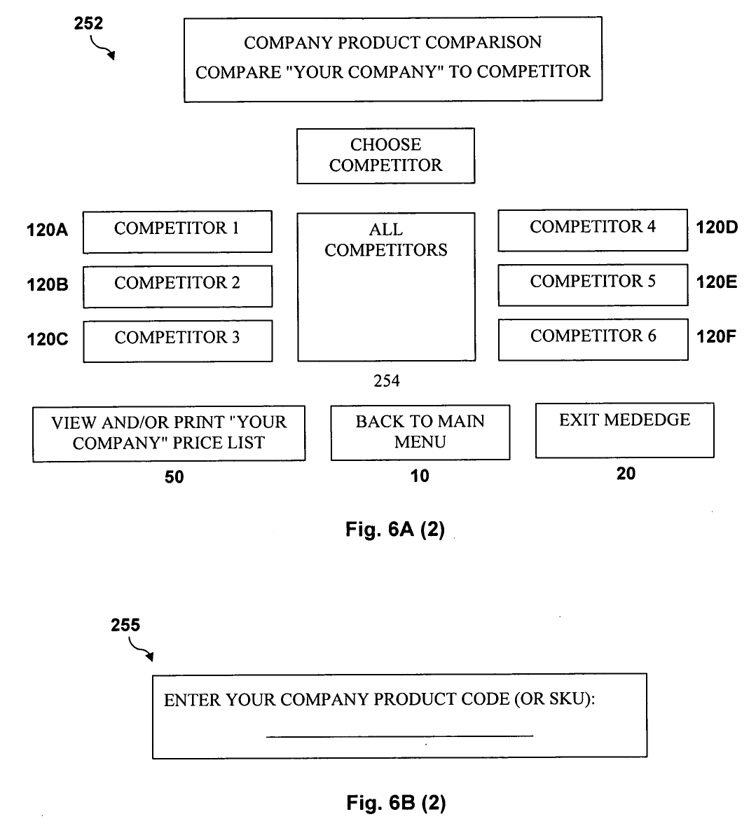

Once the user 120, 130 has made a selection 226 as to product category, the user 120, 130 is asked to make an election as to the method of comparing products. An illustrative election page is shown at screenshot 230 in FIG. 5. The election step is also shown at Box 230 in FIG. 2.

In accordance with step 230, the user 120, 130 may elect to either compare competitors' 120 products with a seller's 120 product, or compare a seller's 120 products with a competitor's 120 target product. Screenshot 230 illustratively shows the source of the target product as “your company.” This is consistent with the customization option which allows the software 200 to be designed for use by a sales representative of a particular seller 120. Thus, in such an instance the sales representative has the option to “Compare Competitors to “[the Sale Representative's Company]” 240 or “Compare [the Sale's Representative's Company] to Competitors” 250. In this instance, step 240 means that the sales representative of a seller 120 is comparing a specific product of his or her own company with products of a competitor 120. Step 250 means that the sales representative is comparing a competitor's specific product with those of the user's company 120. Where the user is a purchaser 130, then either option 240, 250 produces the same results page.

In FIG. 5, buttons 240, 250 are provided for the user 120, 130 in making the election 230. These buttons correlate to steps depicted at 240, 250 in the flowchart of FIG. 2. Button 240 allows a user 120 to choose to compare one of its competitors' products to one of its own specific products. Reciprocally, button 250 allows a user 120 to compare one of its own products to products of various competitors. Comparison is accomplished by entering a product code as shown at Boxes 245, 255 of FIG. 2.

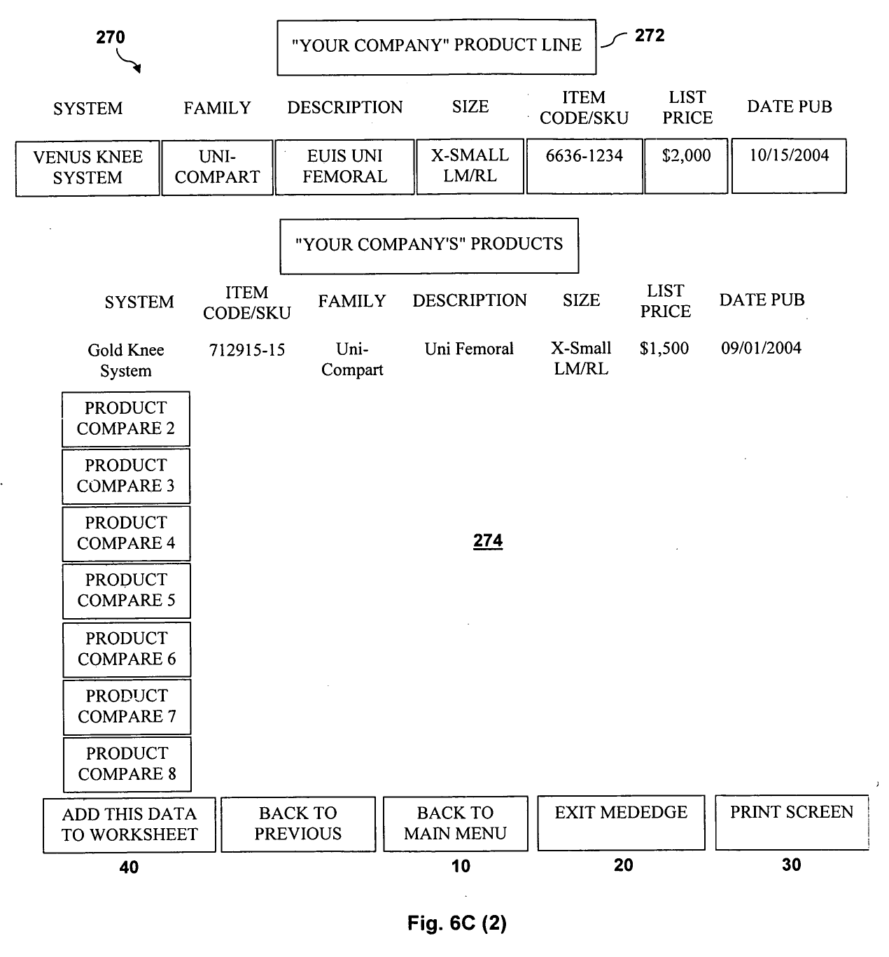

An optional intermediate step allows the user 120, 130 to identify specific competitors for the comparison. This step may be employed regardless of the method of comparison 240, 250 selected. FIG. 6A(1) shows illustrative screenshot 242. This screenshot 242 represents the selection step 242 of the flowchart of FIG. 2. The user 120, 130 may select the “All Competitors” button of link 244. Alternatively, the user 120, 130 may select a specific competitor 120a, 120b, . . . 120n. Similarly, FIG. 6A(2) shows illustrative: screenshot 252. This screenshot 252 represents the selection step 252 of the flowchart of FIG. 2. The user 120, 130 may select the “All Competitors” button of link 254. Alternatively, the user 120, 130 may select a specific seller 120a, 120b, . . . 120f, which may be a competitor. In both screenshots 242, 252, the base number “120” is used to identify the category of seller-users 120.

FIG. 6A(2) also includes link 50, which allows a user 120 to view his or her own price list. When this link 50 is actuated, a separate page (not shown) opens, preferably in spreadsheet format, that includes the information for the seller's 120 own medical products. This is helpful if the user 120 wants to search for his or her own product codes. In this respect, a user 120 may know the name of a product and even the family or class, but not the exact code or number. Afterwards, the user 120 can click back to the previous screen 242 to enter the appropriate number.

FIGS. 6B(1) and 6B(2) demonstrate the step of entering a product code. Where a user 120 is comparing a competitor's product to the specific seller's product, the user 120 will enter the competitor's product number. This step is shown at Box 245 of FIG. 2. Screenshot 245 in FIG. 6B(1) shows the correlating software page for entering the code. Where the seller 120 is comparing one of its own products to a competitor's products, the user 120 will enter the competitor's product number. This step is shown at Box 255 of FIG. 2. Screenshot 255 in FIG. 6B(2) shows the correlating software page for entering the code.

FIGS. 6C(1) and 6C(2) provide illustrative screenshots 260, 270 generated as a result of entering a product code in screenshots 245, 255, respectively. These are results screens. In FIG. 6C(1), screenshot 260 shows fields 262 and 264. Field 262 presents information concerning the competitor's product which correlates to the product number entered in screenshot 245 of FIG. 6B(1). Field 264 presents information concerning equivalent products of the seller 120′. Similarly, FIG. 6C(2) shows screenshot 270, which includes fields 272 and 274. Field 272 presents information concerning the seller's product which correlates to the product number entered in screenshot 255 of FIG. 6B(2). Field 274, in turn, presents information concerning comparable products of a competitor 120.

Screenshots 260, 270 can be grouped according to price, or structured in “tiers” that indicate which products are more costly and which products create better patient outcomes. Customization can be provided to meet an individual user's needs. It is also noted here that the software is designed to correlate comparable products as between the sellers 120a, 120b, 120c, . . .

Various types of information are provided in fields 262 and 272 concerning the product being compared. Such information includes the manufacturer's system or class of products, the family of products, a general description of the product, the size of the product, a confirmation of the product number and the list price. Such information is also provided for the comparative products in fields 264 and 274 along with the latest publication date for the information.

It is noted here that the price may be obtained from publicly available price lists or from those knowledgeable about such matters in the medical industry. Preferably, price lists are obtained directly and periodically from the sellers 120 to ensure that the prices are up-to-date.

In some screenshots, the option is provided to the user 120, 130 to print the screen. Such a step is shown at link “30” in those screenshots, such as screenshots 260 and 270. Alternatively, screenshots 260 and 270 include a link which allows the user 120, 130 to export the listed information to a notepad (not shown). Link 40 is provided for this function. Selecting sequential competitors and adding their respective product information to the worksheet allows the user to build a customized report. The customized report can be reformatted or saved in a different program or printed to provide a comparative report.

In some screenshots, the user 120, 130 is given the option of exiting the software. This may be done by clicking link “20,” such as is indicated in FIG. 5. In FIG. 5, the exit button 20 says “Exit MedEdge.” This indicates a possible trade name for the software 200. Again, it is understood that the use of a trade name is optional and merely for illustration.

In some screenshots, the user 120, 130 is given the option of returning to the “Main Menu.” Such a step is shown at link “10,” such as in screenshots 260 and 270. The “Main Menu” is intended to be the initial election page shown at 230 of FIG. 5.

FIG. 5 shows an additional feature of the software 200, which is the ability to export a price list to a spreadsheet. An example of such a spreadsheet is the Excel® spreadsheet. The step of electing to export a price list to a spreadsheet is shown at step 300 of FIG. 2.

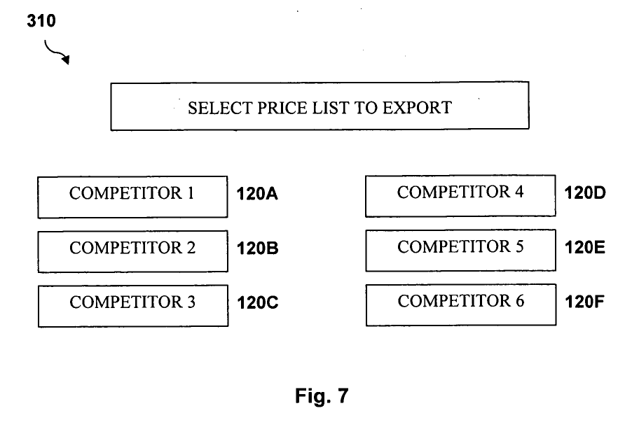

FIG. 7 presents an illustrative screenshot 310 which opens when the user 120, 130 elects to export a spreadsheet 300. The user 120, 130 is given a choice as to which seller's 120 price list to export. Various manufacturers are shown at links 120a, 120b, . . . 120f. The step of selecting a price list for export is shown at Box 310 of FIG. 2. It is understood that the price list will be very long and may include thousands of products and many thousands of lines of information. For this reason, the links 120a, 120b, . . . 120f do not directly print.

It is understood that the present methods and systems are not limited to medical products. The methods and systems are presented in the context of medical products, but have utility and novelty in any context in which comparable products exist among multiple suppliers in an industry having thousands of variable products.

I claim:

1. A method for comparing medical products, each product having a product code, comprising the steps of:
receiving textual information from a first seller as to medical products, such information comprising the first seller's prices for the respective medical products;
placing the information from the first seller onto a database;
receiving textual information from a plurality of additional sellers as to respective medical products, such information comprising each additional seller's prices for the respective medical products;
placing the information from the plurality of additional sellers onto the database;
assigning categories to the medical products of the first seller and the plurality of additional sellers based upon features of the respective medical products;
correlating comparable products as between the first seller and the plurality of additional sellers;
providing software that permits a user to selectively compare information for either the first seller's medical products to the plurality of additional sellers' comparable products by assigned category and product code, or the plurality of additional sellers' products to the first seller's comparable medical products by assigned category and product code.

2. The method of claim 1, wherein
the user interfaces with the software through a web-based platform.

3. The method of claim 1, wherein the software is on a personal computer.

4. The method of claim 3, wherein the software is operated on the personal computer through a compact disc.

5. The method of claim 3, wherein the software is operated by downloading the software onto the personal computer.

6. The method of claim 1, wherein the medical products are medical devices.

7. The method of claim 1, wherein the medical products are pharmaceutical products.

8. The method of claim 1, wherein the medical products are biologic products.

9. The method of claim 1, wherein the medical products are surgical instruments and equipment.

10. The method of claim 1, wherein the assigned categories are selected from the group consisting of “all medical products,” “surgical instruments,” “navigational instruments,” “hips,” “knees,” “shoulders,” “elbows,” “feet,” “hands” and “spinal implants.”

11. The method of claim 1, wherein the textual information of the medical products comprises the product code assigned by the respective first seller and the plurality of additional sellers.

12. The method of claim 11, wherein the textual information of the medical products comprises a published price and a description of medical products.

13. The method of claim 1, wherein the step of providing software comprises:
providing software that permits a user to selectively compare information for either the first seller's medical products to one of the plurality of additional sellers' products by product code, or one of the plurality of additional sellers' products to the first seller's medical products by product code.

14. The method of claim 13, wherein the software further permits the user to export a price list to a spreadsheet program.

15. The method of claim 14, wherein the software further permits the user to design and print out customized worksheets that include selected product information.

16. A system for comparing information concerning medical products, each product having a product code, comprising:
a user interface for a server operator;
a network interface comprising a web browser and a data link;
a server defining a web-based platform having a processor, memory and software for enabling the server operator to communicate with a plurality of users through a global data network, the server enabling the users to:
select a product category;
select a method for comparing products within the selected product category, the methods being either a comparison of a seller's product to a comparable product of a competitor, or comparing a competitor's product to a comparable product of the seller;
select the competitor; and
enter the product code of the medical product to implement the comparison.

17. The system of claim 16, wherein the comparison of products comprises prices for the products.

18. The system of claim 17, wherein the comparison of products further comprises a description for the products.

19. The system of claim 16, wherein the platform further enables the user to:
view information for a product that represents an upgrade, whereby:
when the selected method of comparison is to compare the seller's product to that of a competitor, then the upgraded product is that of the seller; and
when the selected method of comparison is to compare the competitor's product to that of the seller, then the upgraded product is that of the competitor.

20. The system of claim 16, wherein the platform further enables the user to select a price list of a seller for download to a computer.

21. The system of claim 16, wherein the platform further enables the user to select a price list of a seller to export to a printer.

22. The system of claim 16, wherein the product categories that may be selected by the users are selected from the group consisting of “all medical products,” “surgical instruments,” “navigational instruments,” “hips,” “knees,” “shoulders,” “elbows,” “feet,” “hands” and “spinal implants.”

23. A method for comparing medical products as between sellers, each medical product having a product code, the method comprising the steps of:
accessing a computer program through a user interface, the computer program having information concerning the medical products from the sellers, such sellers comprising a manufacturer, and a plurality of additional sellers;
selecting a category of medical products from a menu on the program;
making an election as to whether to (a) compare information concerning a medical product of the manufacturer with information concerning the comparable medical product of one of the sellers, or (b) compare information concerning a medical product of one of the sellers with information concerning a comparable medical product of the manufacturer;
selecting which of the plurality of additional sellers with which to make the product comparison;
entering the product code of the first medical product; and
viewing comparative information of the first medical product.

24. The method of claim 23, wherein the step of accessing a computer program is performed by accessing a web page on a global network.

25. The method of claim 23, wherein the step of accessing a computer program is performed by running a software program on a personal computer.

26. The method of claim 25, wherein the software program is operated on the personal computer through a compact disc.

27. The method of claim 23, wherein the medical products are medical devices.

28. The method of claim 23, wherein the medical products are pharmaceutical products.

29. The method of claim 23, wherein, if the user elects to compare information concerning a medical product of the manufacturer with information concerning the comparable medical product of one of the plurality of additional sellers, the user enters the product code of the selected seller and then views comparative information between the selected seller's product and the manufacturer's product.

30. The method of claim 29, wherein the user further views comparative information between the selected seller's product and the manufacturer's upgrade products.

31. The method of claim 23, wherein, if the user elects to compare information concerning a medical product of one of the plurality of additional sellers with the comparable medical product of the manufacturer, the user enters the product code of the manufacturer and then views comparative information between the manufacturer's product and the selected seller's product.

32. The method of claim 31, wherein the user further views comparative information between the manufacturer's product and the selected seller's upgrade products.
